(19) United States
(12) Patent Application Publication
(10) Pub. No.: US 2020/0336845 A1
(43) Pub. Date: Oct. 22, 2020

(54) Hearing Assist Device that Provides Improved Understanding of Speech in Noisy Environments

(71) Applicants: Yoram PALTI, Haifa (IL); Boris OKLANDER, Haifa (IL)

(72) Inventors: Yoram PALTI, Haifa (IL); Boris OKLANDER, Haifa (IL)

(21) Appl. No.: 16/847,978

(22) Filed: Apr. 14, 2020

Related U.S. Application Data
(60) Provisional application No. 62/836,276, filed on Apr. 19, 2019.

(51) Int. Cl. H04R 25/00

(52) U.S. Cl. CPC H04R 25/505; H04R 25/48

(57) ABSTRACT

A hearing assist apparatus can be implemented by processing sound using a set of at least four band-stop filters arranged in series. Each of the band-stop filters has a respective center frequency and a respective bandwidth, and audio from the environment (which includes both signal plus noise) is filtered by each of the at least four band-stop filters in series to yield a second signal. The second signal is amplified to drive a speaker, and sound from the speaker is routed to the user's ears. Despite the fact that the band-stop filters attenuate portions of the signal, significant improvements in user's ability to understand speech in noisy environments were achieved.

### CROSS REFERENCE TO RELATED APPLICATIONS

This application claims the benefit of U.S. Provisional Application 62/836,276, filed Apr. 19, 2019, which is incorporated herein by reference in its entirety.

### BACKGROUND

Presbycusis or Age Related Hearing Loss (ARHL) is the most common type of hearing loss in the elderly. ARHL is characterized by (1) a loss of hearing sensitivity and (2) a decreased ability to understand speech in the presence of background noise (the “cocktail party effect”). Conventional amplification techniques can be very helpful for overcoming the loss of sensitivity. But conventional techniques have provided a much lower degree of success at overcoming the inability to understand speech.

### SUMMARY OF THE INVENTION

One aspect of the invention is directed to a first hearing assist apparatus. The first hearing assist apparatus comprises a microphone that generates a first signal; and a set of at least four band-stop filters arranged in series. Each of the band-stop filters has a respective center frequency and a respective bandwidth, and the first signal is filtered by each of the at least four band-stop filters in series to yield a second signal. The first hearing assist apparatus also comprises an audio frequency amplifier configured to drive a speaker with an amplified version of the second signal.

In some embodiments of the first hearing assist apparatus, the center frequencies of all the band-stop filters are positioned at regular intervals on a linear scale. In some embodiments of the first hearing assist apparatus, the spacing in frequency between the center frequency of any given band-stop filter and the center frequency of a subsequent band-stop filter is at least two times the bandwidth of the given band-stop filter. In some embodiments of the first hearing assist apparatus, each of the band-stop filters has an order N of at least 6 and a stop band gain that is below −9 dB. In some embodiments of the first hearing assist apparatus, the set of filters has between 8 and 20 band-stop filters arranged in series. Some embodiments of the first hearing assist apparatus further comprise the speaker.

In some embodiments of the first hearing assist apparatus, the center frequencies of all the band-stop filters are positioned at regular intervals on a linear scale, and the size of the regular intervals is user-adjustable. Optionally, in these embodiments, each of the band-stop filters has the same bandwidth B, and B is user-adjustable. Optionally, in these embodiments, the set of filters has between 8 and 20 band-stop filters arranged in series.

Another aspect of the invention is directed to a second hearing assist apparatus. The second hearing assist apparatus comprises a microphone that generates a first signal; and a digital filter having at least four audio frequency stop bands, with an audio frequency pass band positioned between adjacent stop bands. Each of the stop bands has a respective center frequency and a respective bandwidth, and the digital filter inputs the first signal and generates a corresponding filtered second signal as an output. The second hearing assist apparatus also comprises an audio frequency amplifier configured to drive a speaker with an amplified version of the second signal.

In some embodiments of the second hearing assist apparatus, the center frequencies of all the stop bands are positioned at regular intervals on a linear scale. In some embodiments of the second hearing assist apparatus, the spacing in frequency between the center frequency of any given stop band and the center frequency of a subsequent stop band is at least two times the bandwidth of the given stop band. In some embodiments of the second hearing assist apparatus, each of the stop bands has an order N of at least 6 and a stop band gain that is below −9 dB. In some embodiments of the second hearing assist apparatus, the digital filter has between 8 and 20 stop bands. Some embodiments of the second hearing assist apparatus further comprise the speaker.

In some embodiments of the second hearing assist apparatus, the center frequencies of all the stop bands are positioned at regular intervals on a linear scale, and the size of the regular intervals is user-adjustable. Optionally, in these embodiments, each of the stop bands has the same bandwidth B, and B is user-adjustable. Optionally, in these embodiments, the digital filter has between 8 and 20 stop bands.

Another aspect of the invention is directed to a first method of processing an audio signal to assist a person's hearing. The first method comprises inputting the audio signal; and filtering the audio signal using a filter that has between 8 and 20 audio frequency stop bands, with an audio frequency pass band positioned between adjacent stop bands. Each of the stop bands has a respective center frequency and a respective bandwidth, and each of the stop bands has an order N of at least 6 and a stop band gain that is below −9 dB. The first method also comprises generating an output signal based on the filtered audio signal.

In some instances of the first method, the center frequencies of all the stop bands are positioned at regular intervals on a linear scale. In some instances of the first method, the spacing in frequency between the center frequency of any given stop band and the center frequency of a subsequent stop band is at least two times the bandwidth of the given stop band. In some instances of the first method, the center frequencies of all the stop bands are positioned at regular intervals on a linear scale, and the size of the regular intervals is user-adjustable.

### BRIEF DESCRIPTION OF THE DRAWINGS

FIG. 1 is a block diagram of a system that improves a user's ability to understand speech.

FIG. 2 is a frequency response plot for a successful example of the digital filter depicted in FIG. 1.

FIG. 3 is an example of a graphical user interface that may be used to implement the user interface depicted in FIG. 1.

FIG. 4 depicts the frequency content of the noise that was used to test the system.

FIG. 5 is a frequency response plot for an unsuccessful example of the digital filter depicted in FIG. 1.

FIGS. 6A-6D show how the human ear's responsiveness to frequency varies with position within the cochlea.

FIG. 7 schematically depicts tuning curves at six different positions within the cochlea of a non-impaired ear.

FIG. 8 schematically depicts the widening of the tuning curves that is associated with ARHL.

Various embodiments are described in detail below with reference to the accompanying drawings, wherein like reference numerals represent like elements.

### DESCRIPTION OF THE PREFERRED EMBODIMENTS

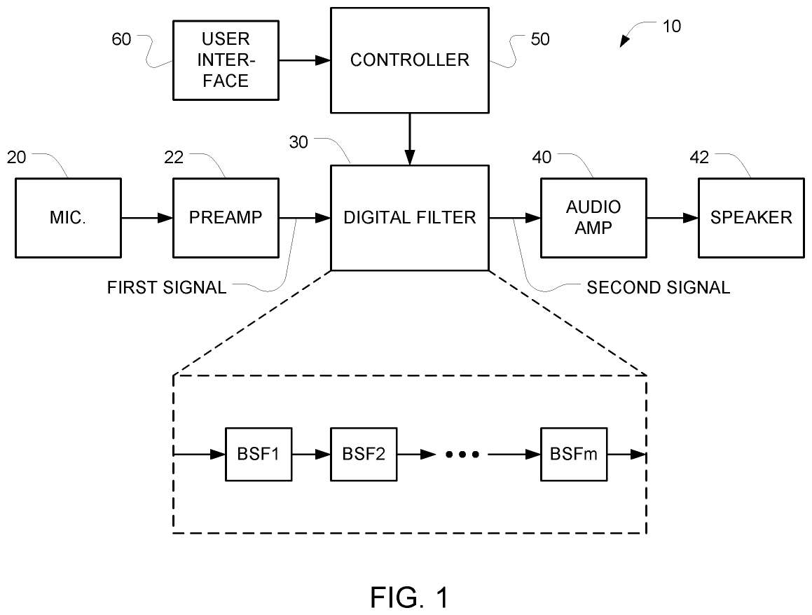

FIG. 1 is a block diagram of a system that has proven to be useful in improving users' ability to understand speech. As in a conventional hearing aid, the system 10 has a microphone 20 that converts sound waves into electricity and a preamplifier 22. And as in a conventional hearing aid, the system 10 has an audio amplifier 40 that drives a speaker 42. And as in conventional hearing aids, the microphone 20 and the speaker 42 may optionally be implemented using a single transducer. But unlike conventional hearing aids, the system 10 has a digital filter 30 that accepts a signal from the microphone (also referred to herein as a first signal), processes that signal using the specific digital filtering techniques described below, and generates an output signal (also referred to herein as a second signal) that is provided to the audio amplifier.

The digital filter 30 implements m band-stop filters BSF1, BSF2, . . . BSFm connected in series, where m is at least 4.

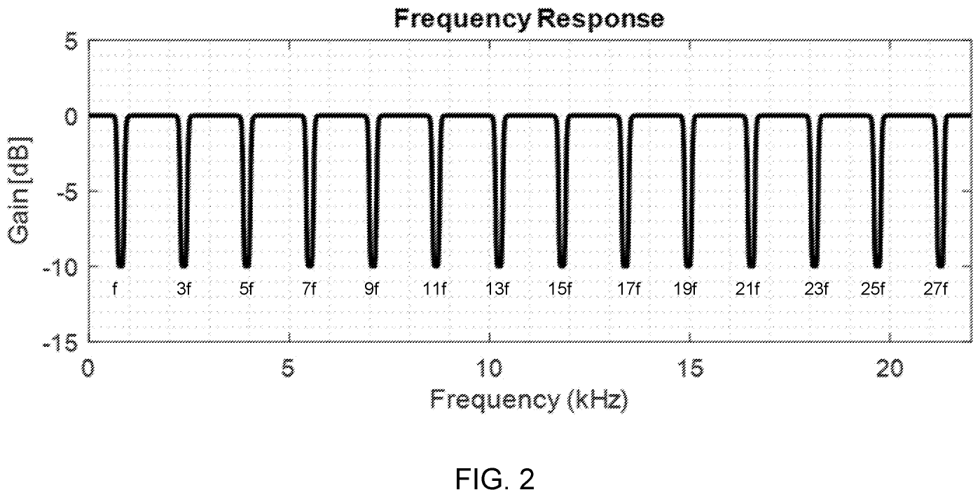

FIG. 2 is a frequency response plot (not to scale) for one example of the digital filter 30 for the situation where m=14. In this example, there are 14 band-stop filters BSF1 through BSF14 arranged in series. Each of these band-stop filters will form a corresponding stop band with a respective center frequency and a respective bandwidth. In this example, each of the 14 stop bands has the same bandwidth B, and the center frequencies of all the stop bands are positioned at regular intervals on a linear scale. More specifically, in the example depicted in FIG. 2, each of the 14 stop bands has a bandwidth B of 735 Hz; the first center frequency f1 is positioned at 787.5 Hz; the center frequencies of the stop bands are positioned at regular intervals of 1575 Hz; the gain in each of the stop bands is −10 dB; and the order N of each of the band-stop filters BSF1 through BSF14 is 16. When this set of parameters is used, the spacing between the center frequencies of any given band-stop filter and its next higher-frequency neighbor will be at least two times the bandwidth of the given band-stop filter.

Experimental testing revealed that filtering using the particular set of parameters identified in the previous paragraph provided improved understandability of speech for most members of a group of test subjects. This experimental testing was accomplished using digital signal processing algorithm software running on a personal computer (PC) to implement a set of m band-stop filters arranged in series, with the center frequencies of all the stop bands positioned at regular intervals on a linear scale. The software was programmed to vary m, the bandwidth B of the stop bands, the spacing between the center frequencies of the stop bands, the gain in the stop bands, and the order N of each of the band-stop filters based on inputs received from users via a user interface.

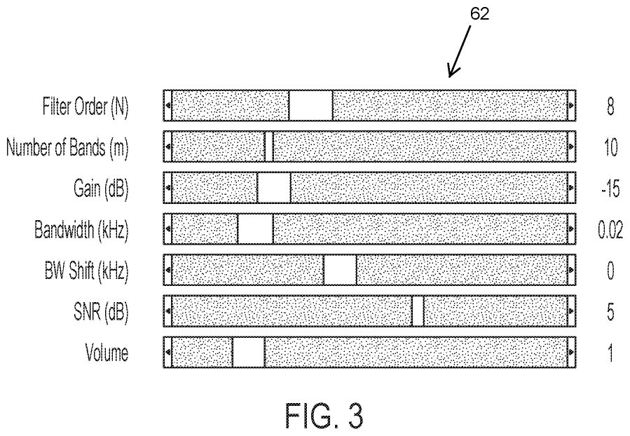

FIG. 3 is an example of a graphical user interface 62 that was used for this purpose on the PC, with the relevant parameters being controlled by the user by adjusting the horizontal position of the sliders.

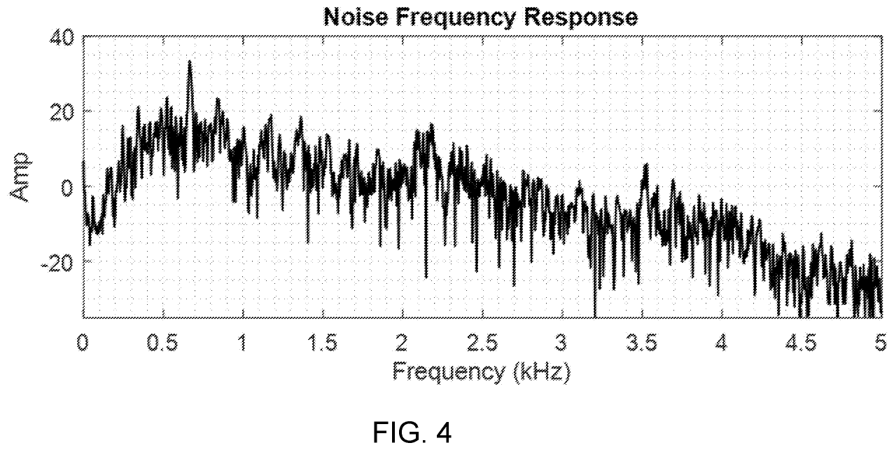

In the experiments, a group of individuals with relevant hearing impairments listened to a recording of a clean speech to which noise was added. The added noise was “cocktail party” type noise, which is a background noise that one would encounter in busy public places such as a busy restaurant, and FIG. 4 depicts the frequency content of this “cocktail party” type noise between 0 and 5 kHz.

The signal to noise ratio (SNR) was controllable. After the SNR was set to a value at which a given test subject could not understand the speech when the digital filter was turned off, The test subjects were given access to a GUI similar to the one depicted in FIG. 3, and the test subjects were able to change the various filter parameters identified above through the GUI while listening to a filtered version of the speech+noise. A GUI button was also provided to switch the digital filter in or out (i.e., on or off), which made it easier for the test subjects to compare the unfiltered version of the speech+noise to the filtered version. The test subjects reported when a set of filtering parameters resulted in improved understanding of the speech. Sets of settings that provided improved understanding for most of the group were identified, and one example of a set of settings that provided improved understanding is described above in connection with FIG. 2. When this set of settings was used for implementing the digital filter 30 (shown in FIG. 1), the test subjects reported significant improvement in their ability to understand the words/content of the speech when the speech+noise was processed by the filter (as compared to when the same speech+noise was heard without applying the filter).

Sets of parameters for the digital filter that provided improved ability to understand speech were found within the following ranges: filter order N of at least six; number of band-stop filters m between 8 and 20; and stopband gain below −9 dB.

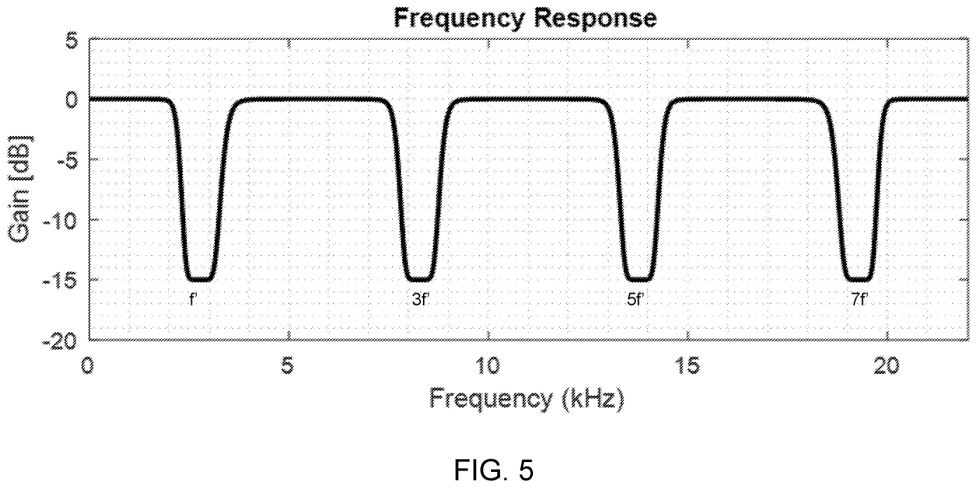

By way of comparison, when the GUI depicted in FIG. 3 was used to set the digital filter parameters on the PC so as to generate the frequency response plot depicted in FIG. 5, understanding of the speech was not improved to a significant degree. In this unsuccessful example, m was set to 4, which means that there were 4 band-stop filters BSF1 through BSF4 arranged in series. Each of those 4 band-stop filters resulted in a corresponding stop band at f, 3f, 5f′, and 7f, where f′ was 2756.25 Hz (with the spacing between consecutive stop bands being 5512.5 Hz). Each of these stop bands had a bandwidth of 2 kHz and a gain of −15 dB, and the order N of each of the band-stop filters BSF1 through BSF4 was 16.

Returning to FIG. 1, in the context of the experimental testing described above, the user interface 60, the controller 50, and the digital filter 30 were all implemented in the PC. In alternative embodiments, the digital filtering algorithms described above may be implemented as an app on a smart phone, in which case the microphone 20, audio amplifier 40, and speaker 42 could be implemented using the microphone, audio amplifier, and earphones of the smart phone; the digital filter 30 and controller 50 could be implemented using the phone's microprocessor; and the user interface 60 could be implemented using the phone's user interface.

In alternative embodiments, the system (including components 20-50) is miniaturized to the size of a hearing aid that rests on or in the user's ear, and the digital filtering algorithms described above are implemented by a digital signal processor (DSP) chip incorporated within the miniaturized system. In these embodiments, the DSP chip can perform the functions of both the digital filter 30 and the controller 50. Alternatively, the DSP chip can perform the functions of the digital filter 30 only, and a separate integrated circuit can perform the functions of the controller 50. In these miniaturized embodiments, the user interface 60 may be implemented using an app on a smart phone that communicates with the controller 50 using any conventional communication approach (e.g., Bluetooth). Of course, a wide variety of alternative user interfaces 60 can be readily envisioned, including but not limited to a set of dials and/or switches that can be actuated by the user to adjust the parameters of the digital filter 30.

In some embodiments, the entire system depicted in FIG. 1 is provided to the end user, including the user interface 60. In these embodiments the end-user has the ability to modify the parameters of the digital filter 30 to improve recognition of speech via the user interface 60. For example, the user could select a first set of parameters for the digital filter 30 when the user finds themselves in a first environment (e.g., a restaurant), and subsequently select a second set of parameters for the digital filter 30 when the user finds themselves in a second environment (e.g., a busy street).

In some embodiments, the user interface 60 allows the user to control all of the parameters described above. (See, e.g., the GUI 62 depicted in FIG. 3.) But in alternative embodiments, the user interface 60 may only allow the user to control a subset of those parameters in order to simplify the user interface. In one example, the user could be provided with a user interface that provides access to only a single variable such as the spacing between the center frequencies of the band-stop filters. Assuming that the digital filter positions the center frequencies of all the band-stop filters at regular intervals on a linear scale, adjusting this single variable would still provide a significant degree of controllability to the user. In another example, the user could be provided with a user interface that provides access to only two variables: (1) the spacing between the center frequencies of the band-stop filters, and (2) the bandwidth of each of the band-stop filters. In these embodiments, the remaining variables (e.g., the order N of the filters and the gain in the stop band) can remain constant (e.g., by leaving the order of the filters fixed at 16 and setting the gain in the stop band to −10 dB). A wide variety of alternative user interfaces can be readily envisioned.

In other embodiments, use of the user interface 60 is restricted to a practitioner (e.g. an audiologist), and the user interface 60 is not provided to the end-user. In these embodiments, the audiologist could set the parameters for the digital filter 30 during an office visit, and those parameters would remain in force until such time that they are updated by the audiologist. In still other embodiments, after a suitable set of parameters for the digital filter 30 has been identified, those parameters could be hardcoded into a dedicated digital filter, in which case the controller 50 can be omitted from the device that is worn by the user.

Note that in the examples noted above, the center frequencies of all the band-stop filters were positioned at regular intervals on a linear scale. But in alternative embodiments, the center frequencies of all the band-stop filters could be positioned at regular intervals on a logarithmic scale or at irregular intervals.

The results described herein may seem counterintuitive because filtering the signal+noise using a set of at least four band-stop filters arranged in series discards a significant portion of the signal, and because the noise is not arriving at a known frequency. For example, when the digital filter parameters described above in connection with FIG. 2 are used, portions of the signal that reside in the stop bands depicted in FIG. 2 are suppressed. Nevertheless, real-world testing has shown that using the filters described herein can significantly improve user's ability to understand speech in noisy environments.

Without being bound or limited by this theory, one possible explanation of why introducing a plurality of stop bands to the frequency response that arrives at the user's ears improves the user's ability to understand speech in noisy environments is as follows.

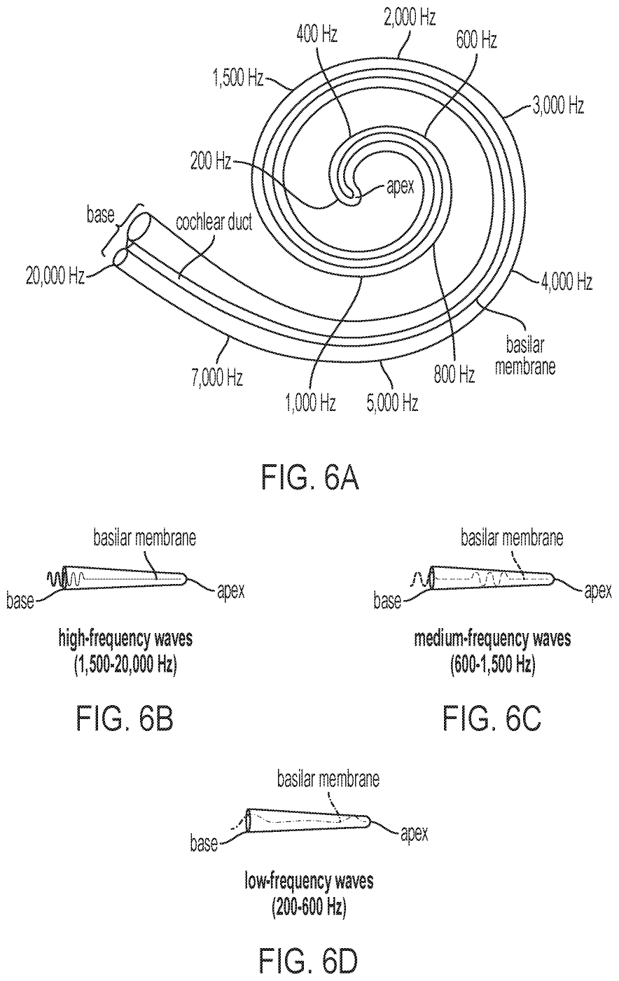

Sound sensation is based on the vibration induced by sound waves in the structures of the inner ear (e.g., the cochlea). The hair cells residing on the vibrating base membrane are responsible for the actual transduction of the mechanical pressure waves into neural signals. The amplitude of base membrane response is a function of the sound wave frequency (in the audio range) in a unique way: the response is location selective, i.e. the response at the basal part of the membrane is limited mostly to high frequencies and the responsiveness to low frequencies increases with distance from the base as seen in FIGS. 6A-6D.

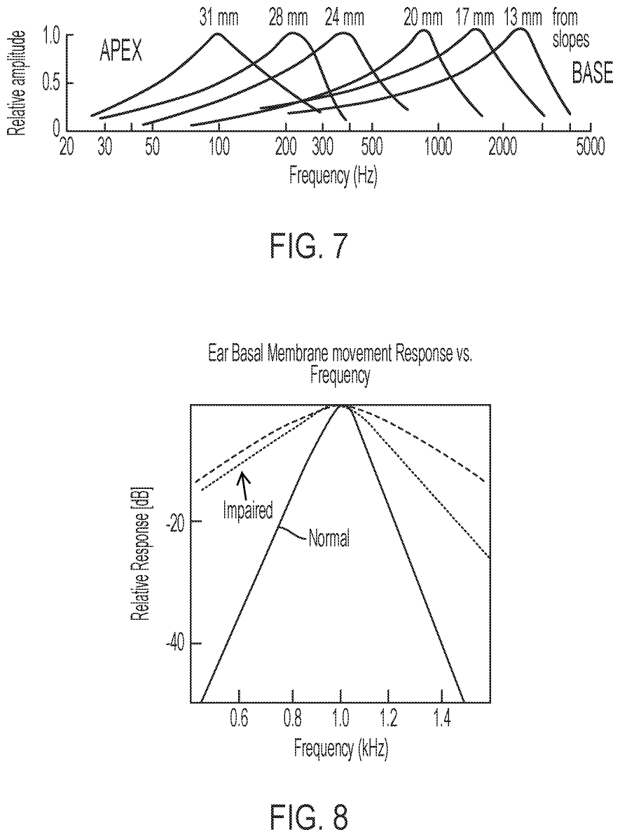

The net effect is a bell-shaped response vs. frequency curve (tuning curve), that is somewhat asymmetric, as illustrated schematically in FIG. 7. An important characteristic of these response curves is the significant frequency overlap of the tuning curves. This overlap can affect the discriminatory power of the auditory system. Moreover, these tuning curves undergo significant changes in some hearing impairments, mainly in the highly prevalent hearing loss with age (presbycusis). The main changes are an overall reduction of sensitivity and a significant asymmetric widening of each curve, as indicated schematically in FIG. 8. More specifically, FIG. 8 shows the relatively narrow frequency response curve for a normal ear (shown in solid lines) and the relatively wider frequency response curves for two impaired ears (shown in dashed and dotted lines). This pathology, which is manifested in increased overlap of the tuning curves, results in a significant reduction of the auditory discriminatory power and consequently, impairment of the ability to understand speech in noisy environments. The inventors theorized that adding the band-stop filters as described herein may shrink the range of audio frequencies that arrive at any given hair cell (or set of hair cells), thereby artificially creating the equivalent of a narrower tuning curve and improving user's ability to understand speech.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A hearing assist apparatus comprising:
a microphone that generates a first signal;
a set of at least four band-stop filters arranged in series, each of the band-stop filters having a respective center frequency and a respective bandwidth, wherein the first signal is filtered by each of the at least four band-stop filters in series to yield a second signal; and
an audio frequency amplifier configured to drive a speaker with an amplified version of the second signal.

2. The apparatus of claim 1, wherein the center frequencies of all the band-stop filters are positioned at regular intervals on a linear scale.

3. The apparatus of claim 1, wherein a spacing in frequency between the center frequency of any given band-stop filter and the center frequency of a subsequent band-stop filter is at least two times the bandwidth of the given band-stop filter.

4. The apparatus of claim 1, wherein each of the band-stop filters has an order N of at least 6 and a stop band gain that is below −9 dB.

5. The apparatus of claim 1, wherein the set of filters has between 8 and 20 band-stop filters arranged in series.

6. The apparatus of claim 1, wherein the center frequencies of all the band-stop filters are positioned at regular intervals on a linear scale, and wherein a size of the regular intervals is user-adjustable.

7. The apparatus of claim 6, wherein each of the band-stop filters has the same bandwidth B, and wherein B is user-adjustable.

8. The apparatus of claim 7, wherein the set of filters has between 8 and 20 band-stop filters arranged in series.

9. The apparatus of claim 1, further comprising the speaker.

10. A hearing assist apparatus comprising:
a microphone that generates a first signal;
a digital filter having at least four audio frequency stop bands, with an audio frequency pass band positioned between adjacent stop bands, each of the stop bands having a respective center frequency and a respective bandwidth, wherein the digital filter inputs the first signal and generates a corresponding filtered second signal as an output; and
an audio frequency amplifier configured to drive a speaker with an amplified version of the second signal.

11. The apparatus of claim 10, wherein the center frequencies of all the stop bands are positioned at regular intervals on a linear scale.

12. The apparatus of claim 10, wherein a spacing in frequency between the center frequency of any given stop band and the center frequency of a subsequent stop band is at least two times the bandwidth of the given stop band.

13. The apparatus of claim 10, wherein each of the stop bands has an order N of at least 6 and a stop band gain that is below −9 dB.

14. The apparatus of claim 10, wherein the digital filter has between 8 and 20 stop bands.

15. The apparatus of claim 10, wherein the center frequencies of all the stop bands are positioned at regular intervals on a linear scale, and wherein a size of the regular intervals is user-adjustable.

16. The apparatus of claim 15, wherein each of the stop bands has the same bandwidth B, and wherein B is user-adjustable.

17. The apparatus of claim 16, wherein the digital filter has between 8 and 20 stop bands.

18. The apparatus of claim 10, further comprising the speaker.

19. A method of processing an audio signal to assist a person's hearing, the method comprising:
inputting the audio signal;
filtering the audio signal using a filter that has between 8 and 20 audio frequency stop bands, with an audio frequency pass band positioned between adjacent stop bands, each of the stop bands having a respective center frequency and a respective bandwidth, wherein each of the stop bands has an order N of at least 6 and a stop band gain that is below −9 dB; and
generating an output signal based on the filtered audio signal.

20. The method of claim 19, wherein the center frequencies of all the stop bands are positioned at regular intervals on a linear scale.

21. The method of claim 19, wherein a spacing in frequency between the center frequency of any given stop band and the center frequency of a subsequent stop band is at least two times the bandwidth of the given stop band.

22. The method of claim 19, wherein the center frequencies of all the stop bands are positioned at regular intervals on a linear scale, and wherein a size of the regular intervals is user-adjustable.
